(19) United States
(12) Patent Application Publication
(10) Pub. No.: US 2014/0051443 A1
(43) Pub. Date: Feb. 20, 2014

(54) Methods and Apparatus for Enhancing Circuit-Switched Call Fallback (CSFB) Service for a Shared Network Node

(71) Applicant: TELEFONAKTIEBOLAGET L M ERICSSON (PUBL), Stockholm (SE)

(72) Inventors: John Walter Diachina, Garner, NC (US); Magnus Olsson, Stockholm (SE); Paul Schliwa-Bertling, Ljungsbro (SE)

(21) Appl. No.: 13/997,410

(22) PCT Filed: Feb. 20, 2013
(86) PCT No.: PCT/SE2013/050142

§ 371 Date: Jun. 24, 2013

Related U.S. Application Data
(60) Provisional application No. 61/604,761, filed on Feb. 29, 2012.

(51) Int. Cl. H04W 36/00

(52) U.S. Cl. CPC H04W 36/0022
USPC 455/436

(57) ABSTRACT

Methods and apparatus enhance a circuit-switched call fallback (CSFB) service for a user equipment (UE) currently connected to a source cell in a serving radio access technology (RAT) communications network. Multiple different mobile network operators share a target CSFB cell selected for CSFB from one or more circuit-switched capable cells that supports circuit-switched services. Each mobile network operator is associated with a corresponding mobile network identifier. The UE transmits a first message requesting a CSFB service to a source cell radio network node serving the source cell. The source node, in response to the first message, sends a second message to the UE including preferred mobile network identifier information and a target CSFB cell identifier. The UE transmits a third message to a target cell node serving the target CSFB cell to trigger the establishment of a circuit-switched call connection for the UE in the target CSFB cell. The target cell radio network node receives the third message, which includes preferred mobile network information to permit the target node to direct the third message to a core network node operated by one of the mobile network operators identifiable based on the preferred mobile network information. That core network node then initiates the requested CSFB service for the UE. Based on the preferred mobile network identifier information, the UE determines whether a location area update procedure must be performed in the target CSFB cell, and if so, transmits a fourth message to trigger the location area update procedure prior to triggering the establishment of a circuit-switched call connection.

### TECHNICAL FIELD

This technology relates to radio communications involving different radio access technologies (RATs), and in particular, to providing circuit-switched services in a multimedia mobile network.

### BACKGROUND

UMTS (Universal Mobile Telecommunications System) Terrestial Radio Access Network (UTRAN) is a 3G technology for wireless provision of multimedia services. The deployment of Evolved UTRAN (E-UTRAN), also known a Long Term Evolution (LTE) and Evolved Packet Core (EPC), allow telephony services to be migrated from a traditional circuit switched (CS) system to a packet switched (PS) system, e.g., provided by Multimedia Telephony Service for IMS (MTSI). This requires the Internet Protocol (IP) Multimedia Subsystem (IMS) to be widely deployed earlier than eUTRAN and EPC. Circuit-switched fallback (CSFB) is a service that allows the reuse of deployed CS core network infrastructure, e.g., 2G/3G, to support voice service when introducing eUTRAN and EPC, e.g., 4G.

With the introduction of a FULL-Multi-Operator Core Network (FULL-MOCN) feature, a common radio access network (RAN) node, e.g., a base station node, may be shared by multiple Mobile Switching Centres (MSCs)/Serving GPRS Support Nodes (SGSNs). Each MSC/SGSN is associated with a different Public Land Mobile Network (PLMN) identified using a unique PLMN identifier (ID) value. For the case where a user terminal (UE) or mobile station (MS) is operating in an E-UTRAN service area and is attached to the UTRAN/GSM/EDGE Radio Access Network (GERAN) CS domain, a CS fallback (CSFB) from E-UTRAN access to UTRAN/GERAN CS domain access may become necessary if a UE/MS cannot initiate an IMS voice session because it is either not IMS-registered or IMS voice services are not supported in the E-UTRAN service area.

According to 3GPP TS 23.272 (clause 6 and 7), CSFB can be performed using Radio Resource Control (RRC) Connection Release With Redirect (RWR) when reselection-based CSFB is triggered to the target UTRAN/GERAN service area or PS Handover (PSHO) when handover based CSFB is triggered to the target UTRAN/GERAN service area, where the target service area supports FULL-MOCN operation. Thus, CSFB may be used with RWR or PSHO.

In order to continue with the CS service establishment in the CS domain after a circuit-switched fall back to a target RAN cell with CS-domain support, the UE/MS must determine if the Location Area Identifier (LAI) selected for its use within the CSFB target cell (referred to as the “selected LAI”) is the same as the LAI for which the UE/MS is currently registered (referred to as the “registered LAI”). This is determined by the UE/MS by comparing the “selected LAI” with its “registered LAI”. See, e.g., 3GPP TS 24.008 (clause 4.4.1).

At CSFB, the UE/MS can receive an indication of a LAI supported by the CSFB target cell in a GERAN System Information Type 3 (SI3) message (see 3GPP TS 44.018, clause 9.1.35), which is provisioned to the UE/MS during the actual CSFB procedure. According to current specifications, the LAI indicated by this message will be associated with the “common” PLMN supported in the CSFB target cell which the UE/MS will assume is the “selected LAI”. In the case where the UE's “registered LAI” and the LAI indicated by GERAN System Information Type 3 message do not match, the UE will, upon arriving in the CSFB target cell, perform a Location Area Update (LAU) procedure, become registered for CS service with a less than optimal Mobile Switching Center (MSC) if the LAI indicated by the GERAN System Information Type 3 message is not the “selected LAI” and then perform the CS service establishment procedure.

There are, however, implications from the support for FULL-MOCN in the target RAN/cell regarding the UE's ability to accurately determine whether or not it needs to perform a LAU in the CSFB target cell. Without the ability to accurately make this determination, a UE/MS may falsely conclude that a LAU is not needed for the case where the “registered LAI” is the same as the LAI indicated by the GERAN System Information Type 3 message but is not the “selected LAI”, and therefore, the UE/MS immediately attempts CS call establishment in the CSFB target cell. In this case, the attempted CS call establishment may fail, or at least result in the UE/MS establishing CS service with a less than optimal MSC. In case of CS call establishment failure, the UE/MS must then perform a LAU, and after which, again attempt CS call establishment. The net impact of the UE/MS initially (and falsely) concluding that a LAU is not needed and experiencing CS call establishment failure is that the UE/MS user experiences additional delay in establishing the CS call, adversely affecting the user's perceived quality of experience during CSFB triggered CS call establishment. Conversely, a UE/MS may also falsely conclude that an LAU is needed for the case where the “registered LAI” is not the same as the LAI Indicated by the GERAN System Information Type 3 message, and therefore performs a LAU in the CSFB target cell prior to attempting CS call establishment. In this case, the LAU may fail, or at least result in the UE/MS becoming registered with a less than optimal MSC. The net impact of the UE/MS initially (and falsely) concluding that a LAU is needed and experiencing LAU failure is again that the UE/MS user experiences additional delay in establishing the CS call, adversely affecting the user's perceived quality of experience during CSFB triggered CS call establishment.

A cell that supports FULL MOCN is denoted as a shared cell, and a shared cell can be shared among multiple, e.g., 5, different PLMNs. For the example of 5 different PLMNs, the UE/MS may, prior to CSFB, be registered to one out of the 5 different PLMNs. During a pre-CSFB registration procedure performed when the UE/MS is served by an E-UTRAN cell, the Mobile Management Entity (MME) selects a particular PLMN for the UTRAN/GERAN CS domain (as described in 3GPP TS 23.272, clause 4.3.2), which is conveyed to the UE/MS along with the corresponding Location Area Code (LAC) during the CS domain registration procedure and used to establish the “registered LAI” stored by the UE/MS.

The UE/MS's “registered LAI” includes the PLMN for which it is registered (referred to as the “registered PLMN”) plus the Location Area Code (LAC) associated with the UTRAN/GERAN cells that support that “registered PLMN”. The “registered PLMN” may be one of the additional shared PLMNs included, for example, in a new System Information Type 16 and System Information Type 17 message, where all sharing PLMNs are broadcast/listed, and as such, may be different from the common PLMN included within the legacy System Information Type 3 message which can, for example, be sent to the UE/MS during PS HO based CSFB. Hence, even though the LAC is common for all PLMNs (including the additional shared PLMNs as well as the common PLMN) supported by a target UTRAN/GERAN cell, the mobile station's “registered LAI” can be different from the LAI included in the SI3 since, in present systems, the LAI included in the SI3 is always based on the common PLMN supported by the target UTRAN/GERAN cell. This means that in order for a UE/MS to make an accurate decision regarding whether a LAU is necessary upon arriving in a UTRAN/GERAN cell as a result of CSFB, the UE/MS needs to know more than just the common PLMN (e.g., provided by SI3) supported by the target UTRAN/GERAN cell.

In summary, for the legacy non-sharing case, the “registered LAI” of the MS established during the pre-CSFB registration process is compared to the LAI included in the SI3 message associated with a GERAN cell to which CSFB may subsequently occur. The “registered LAI” is compared to the LAI indicated by the SI3 message (i.e. the “common PLMN” plus the LAC provided by the SI3 message), and thus, the MS will always conclude that a LAU is necessary upon arriving in the CSFB target cell in case its “registered LAI” is not the LAI indicated by the SI3 message. In the shared cell scenario, the “registered LAI” of the MS established during the pre-CSFB registration process will be the same as either the “common PLMN” plus LAC provided by the SI3 message or one of the additional shared PLMNs listed in the SI16 & SI17 messages plus the LAC provided by the SI3 message. The SI3 message also contains an indication whether the CSFB target cell supports FULL-MOCN. For PS HO-based CSFB, the MME may have (during the PS HO preparation phase) selected a SI16/SI17-based PLMN for the MS to use upon arrival in the CSFB target cell that is the same as the PLMN of the UE/MS “registered LAI” and is not the common PLMN. In this case the “registered LAI” will be compared to the “common PLMN” plus LAC provided by SI3, and the MS will falsely conclude that a LAU is necessary when in fact the SI16/SI17-based PLMN selected and the corresponding LAC (together comprising the “selected LAI”) is the same as its “registered LAI,” in which case a LAU is not needed.

As outlined above, during the CSFB procedure, the MS is provisioned with the SI3 message that provides an indication whether the CSFB target cell supports FULL-MOCN, the “common PLMN,” and the LAC common to all shared cells. However, the MS does not receive a list of additional shared PLMNs supported by the CSFB target cell; nor does it have any knowledge of which specific PLMN (the common PLMN or a specific additional shared PLMN) is selected for it by the MME during the PS HO preparation phase, and will therefore, in the absence of any additional information, assume the LAI indicated by the SI3 message is the “selected LAI”. Note that the PLMN selected by the MME during the PS HO preparation phase for PS HO based CSFB is what should be used by the MS when performing LAU/CS call setup in the CSFB target cell.

It would therefore be desirable to provide the UE/MS with additional information allowing it to more accurately perform LAI verification (i.e. comparing its “registered LAI” with the actual “selected LAI” instead of what the UE/MS assumes is “selected LAI”) when PS HO-based CSFB into a cell with FULL-MOCN support is performed. But to do this for the FULL-MOCN case by requiring the UE/MS to read S13/S116/SI17 messages from the broadcast common control channel (BCCH) upon arrival in the CSFB target cell incurs additional delay associated with system information acquisition and a potential LAU procedure. This delay negatively impacts the MS user experience and should be avoided. In addition, even if the UE/MS acquires an SI16/SI17 message in the CSFB target cell that supports multiple PLMNs, it will not be clear which specific PLMN was selected by the MME during the PS HO preparation phase. As a result, the UE/MS does not know which PLMN to use for performing the LAI verification (and therefore will not be able to accurately determine if a LAU is needed) and will not be able to direct subsequent LAU or CS call establishment signaling to the PLMN associated with the “selected LAI”.

### SUMMARY

One aspect of the technology described in this application relates to methods and apparatus for enhancing a circuit-switched call fallback (CSFB) service for a user equipment (UE) currently connected to a source cell in a serving radio access technology (RAT) communications network. Multiple different mobile network operators share a target CSFB cell selected for CSFB from one or more circuit-switched capable cells in a target radio access technology that supports circuit-switched services. Each mobile network operator is associated with a corresponding mobile network identifier. The UE transmits a first message requesting a CSFB service to a source cell radio network node serving the source cell. In response to the first message, the UE receives a second message received from the source cell radio network node which includes preferred mobile network identifier information associated with a preferred mobile network and a target CSFB cell identifier. The UE transmits a third message to a target cell radio network node serving the target CSFB cell to trigger the establishment of a circuit-switched call connection for the UE in the target CSFB cell. The third message includes preferred mobile network information to permit the target cell radio network node to direct the third message to a core network node operated by one of the mobile network operators identifiable based on the preferred mobile network information.

In example embodiments, the UE has a registered location area identifier (LAI) different from a LAI corresponding to the preferred mobile network intended to serve the UE in the target RAT communications network that supports circuit-switched services in the one or more circuit-switched capable cells. The UE determines, based on the preferred mobile network identifier information, whether a location area update procedure must be performed in the target CSFB cell, and if so, transmits a fourth message to trigger the location area update procedure. The fourth message may be sent prior to the third message.

The preferred mobile network identifier information may include one or more of the following: mobile network operator index information, a list of network identifier information for each of the multiple mobile network operators supported in the target cell, an indicator indicating whether the UE needs to perform the location area update procedure in the target CSFB cell, or an indication of a location area identifier (LAI) corresponding to the preferred mobile network.

One example implementation has the first message as an extended service request message, and the second message as a cell change message that includes either: a list of network identifier information for each of the multiple mobile network operators and mobile network operator index information useable by the UE to identify a specific list element and thereby determine whether the UE must perform a location area update procedure in the target cell, or a flag indicating whether the UE needs to perform a location area update procedure in the target cell, or an indication of a location area identifier (LAI) corresponding to the preferred mobile network useable by the UE to determine whether to perform a location area update procedure in the target cell. The cell change message may be for example a packet-switched handover message or a release with redirect (RWR) message. The third and fourth messages may include mobile network operator index information allowing the target cell radio network node to direct the third and fourth messages to a core network node operated by the preferred mobile network operator. The second message may include an indicator in a system information message indicating whether the UE needs to perform the location area update procedure in the target CSFB cell, where the location area update procedure registers the UE with the LAI corresponding to the preferred mobile network while in the target CSFB cell.

Another aspect of the technology described in this application relates to methods and apparatus for the source cell radio network node serving the source cell. The source cell radio network node receives a first message requesting a CSFB service from the UE, and transmits to the UE, in response to the first message, a cell change message including preferred mobile network identifier information associated with a preferred mobile network to trigger establishment of a circuit-switched call connection for the UE in the target CSFB cell.

In an example implementation, the first message is an extended service request message, and the cell change message includes either: a list of network identifier information for each of the multiple mobile network operators and mobile network operator index information useable by the UE to identify a specific list element and thereby determine whether the UE must perform a location area update procedure in the target cell, or a flag indicating whether the UE needs to perform a location area update procedure in the target cell, or an indication of a location area indicator (LAI) corresponding to the preferred mobile network useable by the UE to determine whether to perform a location area update procedure in the target cell. The cell change message may be for example a packet-switched handover message or a release with redirect (RWR) message.

Another aspect of the technology described in this application relates to methods and apparatus for the target cell radio network node. The target cell radio network node receives a message from the UE requesting a CSFB service in the target CSFB cell, where the message includes preferred mobile network identifier information. The target cell radio network node sends, based on the preferred mobile network identifier information, the CSFB service request to a core network node identifiable from the preferred mobile network identifier information and associated with one of the multiple different mobile network operators to enable the core network node to initiate the requested CSFB service for the UE. The target cell radio network node assists in establishing a circuit-switched call connection for the UE in the target CSFB cell in response to sending the core network node a request to initiate the requested CSFB service for the UE. One example of the message is a connection management service request message.

### BRIEF DESCRIPTION OF THE FIGURES

FIG. 1 illustrates in function block form a UTRAN/LTE combined Architecture;

FIG. 2 illustrates in function block form a CSFB procedure UTRAN/LTE combined Architecture that include a GERAN/UTRAN CSFB target cell shared by multiple PLMNs 1-N;

FIG. 3 illustrates a flowchart of non-limiting, example UE procedures for CSFB to a GERAN/UTRAN CSFB target cell shared by multiple PLMNs 1-N;

FIG. 4 illustrates a flowchart of non-limiting, example procedures implemented by a source radio network node for CSFB to a GERAN/UTRAN target cell shared by multiple PLMNs 1-N;

FIG. 5 illustrates a flowchart of non-limiting, example procedures implemented by a target radio network node for CSFB to a GERAN/UTRAN to its target cell shared by multiple PLMNs 1-N;

FIG. 6 illustrates a function block diagram of an example UE for implementing CSFB to a GERAN/UTRAN target cell shared by multiple PLMNs 1-N;

FIG. 7 illustrates a function block diagram of an example radio network node for implementing CSFB to a GERAN/UTRAN target cell shared by multiple PLMNs 1-N; and

FIG. 8-10 illustrates signaling diagrams for CSFB to a GERAN/UTRAN to its target cell shared by multiple PLMNs 1-N in accordance with non-limiting, example embodiments.

### DESCRIPTION OF NON-LIMITING EXAMPLE EMBODIMENTS

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

A cell is associated with a base station, where a base station comprises in a general sense any node transmitting radio signals in the downlink (DL) and/or receiving radio signals in the uplink (UL). Example base stations are a NodeB, eNodeB, eNB, macro/micro/pico radio base station, home eNodeB, relay, repeater, sensor, transmitting-only radio nodes or receiving-only radio nodes. A base station may operate or at least perform measurements in one or more frequencies, carrier frequencies or frequency bands and may be capable of carrier aggregation. It is understood that the problem described in the background is not limited to the LTE, UTRAN, and GERAN radio access technologies (RATs). Indeed, the problem may occur among any RATs to which a UE is allowed to handover. Thus, although the description below is in the example context of LTE, UTRAN, and GERAN radio access technologies (RATs), they are only example, and the technology may be applied to other RATs and inter-RAT handover scenarios.

Although the description is given for user equipment (UE), also referred to as a mobile station (MS), it should be understood by those skilled in the art that “UE” is a non-limiting term comprising any wireless device or node equipped with a radio interface allowing for at least one of: transmitting signals in the UL and receiving and/or measuring signals in the DL. Some examples of UE in its general sense are a PDA, a laptop, a mobile radio station. A UE herein may comprise a UE (in its general sense) capable of operating or at least performing measurements in one or more frequencies, carrier frequencies, component carriers or frequency bands. UEs can operate using different RATs.

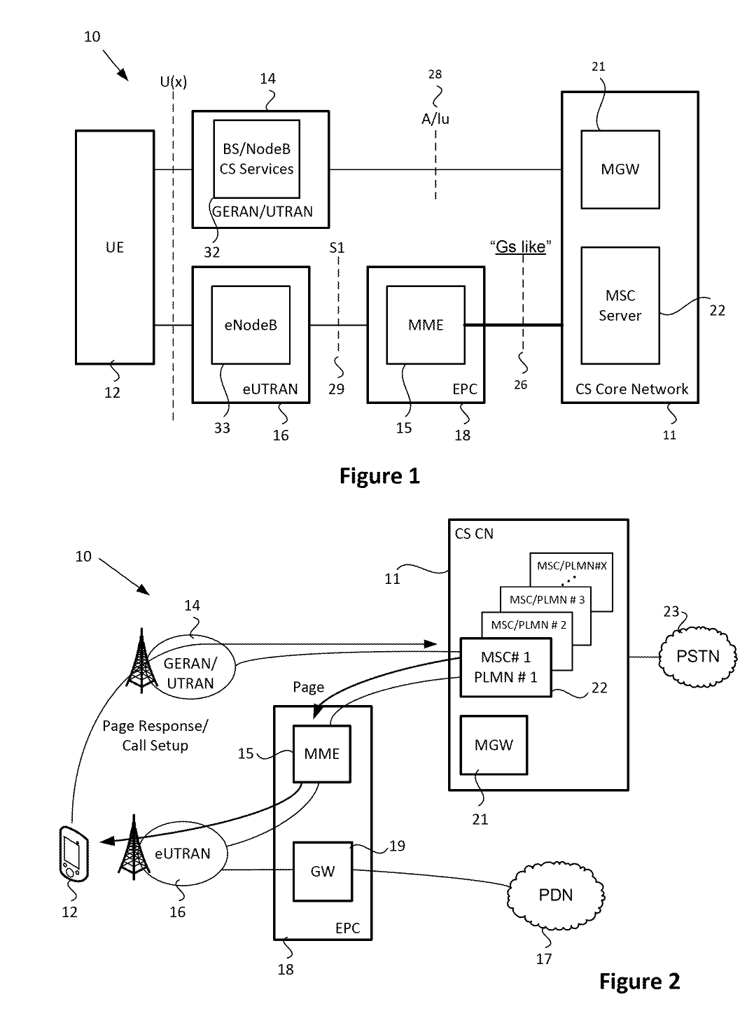

A network 10 is shown generally in FIGS. 1 and 2. A CS Core Network (CN) 11 includes a Media Gateway (MGW) 21 and a Mobile Switching Center (MSC) 22. Other aspects of the CS domain are also assumed to be present, such as the Home Location Register (HLR), etc. but are omitted for clarity. The CS Core Network 11 provides voice service from a Public Switched Telephone Network (PSTN) 23 to user equipment (UE) 12 through 2G/3G Radio Access Network (RAN) cells, e.g., GERAN (GSM/Edge Radio Access Network) or UTRAN 14. The network 10 also includes an Evolved Packet System (EPS) comprising an eUTRAN 16 providing PS services, including voice, via one or more eUTRAN cells. PS services are provided from a Packet Data Network 17 via an Evolved Packet Core (EPC) network 18 including a serving gateway 19 and a Mobility Management Entity (MME) 15. The MME 15 provides control aspects including idle mode UE location tracking as well as paging procedures in accordance with eUTRAN standards.

In the network 10 FIGS. 1 and 2, voice service may be provided to the UE 12 in the PS domain via the eUTRAN cells or in the CS domain via the GERAN/UTRAN cells since the coverage areas provided by these cells is expected to involve a very significant degree of overlap. In the present example, it is considered that the UE 12, also referred to as a mobile station (MS) is operating in an eUTRAN cell controlled by eUTRAN 16 (also known as an LTE cell) with one or more active packet services that do not include a voice component, i.e. there is no ongoing voice service in the eUTRAN cell. When a voice service is needed, it can be established in the PS domain as a VoIP service within the current eUTRAN cell. However, if the roll out of eUTRAN service is phased in that IMS service is not present at initial LTE deployment, there may be eUTRAN coverage areas that are overlapped by GERAN/UTRAN coverage areas. In these overlapped areas, continuity of voice service initiated within eUTRAN cells may not be possible when the UE 12 approaches the edge of eUTRAN coverage due to the lack of the domain transfer function (DTF) associated with IMS service deployment. As such, to allow voice calls to be established in an eUTRAN cell when IMS is not supported would result in those calls being dropped if the UE were to leave the LTE coverage area. If instead, at the point when voice service is desired, the UE 12 leaves the eUTRAN cell, even though eUTRAN coverage is still available, and take advantage of the overlaid coverage area of a 2G (GERAN) or 3G (UTRAN) cell, then the voice service can be established in the CS domain using a 2G/3G cell without concern for it being prematurely dropped as could happen if it was established in the eUTRAN cell, since 2G/3G cell coverage is considered to be ubiquitous. For example, establishing a voice service while the UE 12 is within LTE coverage triggers a handover of the UE 12 from the eUTRAN cell to a GERAN/UTRAN cell where the desired voice service is established in the CS domain.

As illustrated with arrows in FIG. 2, a voice call page is received by the MME 15 of the EPC 18 from an MSC 22 of the CS Core network 11 (there are multiple different PLMNs shown which will be described further below). The MME 15 forwards the page to the eNodeB 33 (shown in FIG. 1) of the eUTRAN cell. The page the MME sends to the eNodeB indicates voice call establishment in the CS domain is required. The eNodeB 33 is aware of one or more active PS services for the UE 12 and is thus able to access a measurement report history for the UE 12 in the eUTRAN 16 (step 102). The eNodeB 33 uses the existing measurement report history to determine neighbor GERAN/UTRAN cells that can be selected as PS Handover candidates. The eNodeB sends a page to the UE 12, and upon receiving the page response, it selects one of these neighbor GERAN/UTRAN cells and triggers a PS handover procedure. Upon receiving a service request from the UE (via the eNodeB) in response to the paging attempt, the MME will realize that an Inter-RAT PS handover to GERAN/UTRAN can be performed and can therefore respond to the service request by ordering the eNodeB to perform an Inter-RAT PS HO to a GERAN/UTRAN cell for that UE instead of performing call establishment procedures in the packet switched domain. In the handover procedure, the UE 12 is sent a PS Handover command directing the UE to the selected GERAN/UTRAN cell. The PS Handover command includes a “cause code” indicating that a UE CS domain voice call needs to be established. After completion of the PS Handover procedure, the UE proceeds as if paged for a voice call in the CS domain by sending a page response to the MSC 22. CS domain voice service is then established between the UE 12 and the GERAN/UTRAN 14 and the CS CN 11 as per legacy procedures for mobile terminating (MT). Legacy procedures similarly support the case of mobile originating (MO) call setup resulting in the UE receiving a PS Handover command directing it to leave an eUTRAN cell and enter a CSFB target cell where it establishes a CS domain voice call.

If the UE 12 and the GERAN/UTRAN 14 do not both support dual transfer mode, then once the voice service is established in the CS domain the PS resources are dropped. If the UE and the GERAN/UTRAN 14 both support dual transfer mode, then the PS resources are maintained in parallel with the resources required for the CS domain speech service. PS handover to a UTRAN cell can be considered as a logical equivalent of PS handover to a GERAN cell where dual transfer mode is supported since UTRAN allows for PS domain and CS domain services to operate in parallel.

Turning now to the multiple MCSs 22 in the CS CN that share one or more GERAN/UTRAN cells that support CS services including CSFB. Each of the multiple MCSs 22 corresponds to one of multiple PLMNs #1-N. As described in the background, it would be desirable for multiple reasons for the UE requesting CSFB service from the shared target GERAN/UTRAN cell to know whether a LAU procedure needs to be performed for the CSFB call at the CSFB target cell and for the target node to know to which of the multiple MSCs/PLMNs to communicate with to perform the LAU and establish a circuit-switched call connection with the UE.

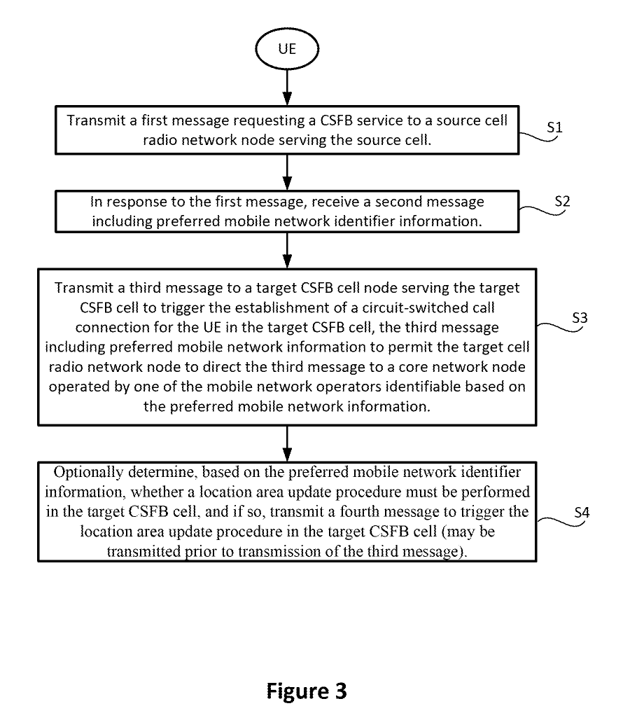

FIG. 3 illustrates a flowchart of non-limiting, example UE procedures for CSFB to a GERAN/UTRAN target cell shared by multiple PLMNs 1-N. The UE is currently connected to a source cell in a serving radio access technology (RAT) communications network, e.g., an eNTRAN cell, where multiple different mobile network operators share a target CSFB cell, e.g., a GERAN/UTRAN cell, selected for CSFB from one or more circuit-switched capable cells that supports circuit-switched services. Each mobile network operator, e.g., a PLMN operator, is associated with a corresponding mobile network identifier, e.g., a PLMN identifier. The UE transmits a first message requesting a CSFB service to a source cell radio network node serving the source cell (step S1), and in response, the UE receives a second message including preferred mobile network identifier information and a target CSFB cell identifier (step S2). The UE then transmits a third message to a CSFB target cell node serving the target CSFB cell to trigger the establishment of a circuit-switched call connection for the UE in the target CSFB cell (step S3). The third message includes preferred mobile network information to permit the radio network node target cell radio network node to direct the third message to a core network node operated by one of the mobile network operators identifiable based on the preferred mobile network information. A fourth optional step S4 relates to a possible location area update procedure. The UE has a registered location area identifier (LAI) different from the LAI corresponding to the preferred mobile network intended to serve the UE in the target RAT communications network that supports circuit-switched services in the one or more circuit-switched capable cells. The UE determines, based on the preferred mobile network identifier information, whether a location area update procedure must be performed in the target CSFB cell, and if so, transmits a fourth message to trigger the location area update procedure in the CSFB target cell (step S4). The fourth message may be transmitted prior to transmission of the third message.

In example embodiments, the preferred mobile network identifier information includes mobile network operator index information. The preferred mobile network identifier information may also include a list of network identifier information for each of the multiple mobile network operators supported in the target cell. The preferred mobile network identifier information includes an indicator indicating whether the UE needs to perform the location area update procedure in the CSFB target cell. Moreover, the third and fourth messages may include mobile network operator index information that allows the target cell radio network node to direct the third message to a core network node operated by the preferred mobile network operator.

In example embodiments, the first message may be an extended service request message. The second message may be a cell change message, e.g., a packet-switched handover message or a release with redirect (RWR) message, that includes either: (1) a list of network identifier information for each of the multiple mobile network operators and mobile network operator index information useable by the UE to identify a specific list element and thereby determine whether the UE must perform a location area update procedure in the target cell, (2) a flag indicating whether the UE needs to perform the location area update procedure in the target CSFB cell and mobile network operator index information, or (3) the network identifier information specific to the mobile network operator corresponding to the PLMN selected by the MME during the CSFB procedure and mobile network operator index information corresponding to the selected PLMN. For a RWR-based CSFB procedure, the UE/MS may be provided with this same information within a Radio Resource Control (RRC) Connection Release message.

The preferred mobile network identifier information may includes an indicator in a system information message indicating whether the UE needs to perform the location area update procedure in the target CSFB cell. The location area update procedure registers the UE with the LAI corresponding to the preferred mobile network intended to serve the UE in the target CSFB cell.

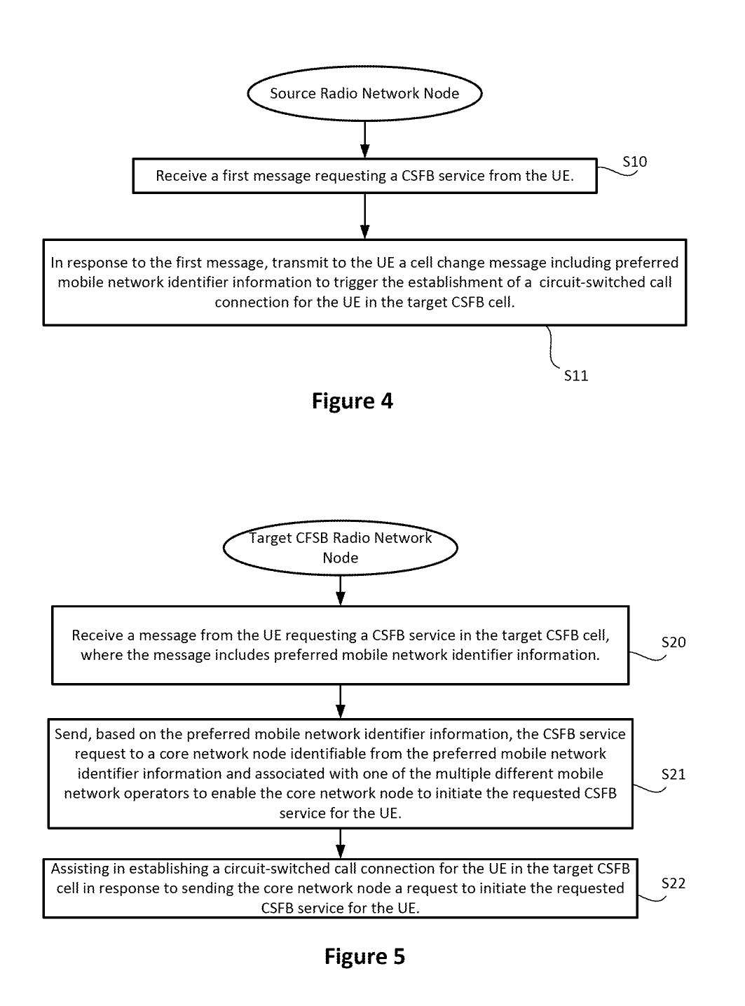

FIG. 4 illustrates a flowchart of non-limiting, example procedures implemented by a source radio network node for CSFB to a GERAN/UTRAN target cell shared by multiple PLMNs 1-N. The source cell radio network node, which is currently serving the UE in a source cell, receives a first message requesting a CSFB service from the UE (step S10). In response to the first message, the source cell radio network node transmits to the UE a cell change message including preferred mobile network identifier information to trigger establishment of a circuit-switched call connection for the UE in the CSFB target cell (step S11).

FIG. 5 illustrates a flowchart of non-limiting, example procedures implemented by a target radio network node for CSFB to a GERAN/UTRAN to its target cell shared by multiple PLMNs 1-N. The CSFB target cell radio network node receives a message from the UE requesting a CSFB service in the target CSFB cell and providing preferred mobile network identifier information (step S20). Based on the preferred mobile network identifier information, the target cell radio network node sends the CSFB service request to a core network node identifiable from the preferred mobile network identifier information and associated with one of the multiple different mobile network operators to enable the core network node to initiate the requested CSFB service for the UE (step S21). The target cell radio network node then assists in establishing a circuit-switched call connection for the UE in the target CSFB cell in response to a message from the core network node to initiate the requested CSFB service for the UE (step S22).

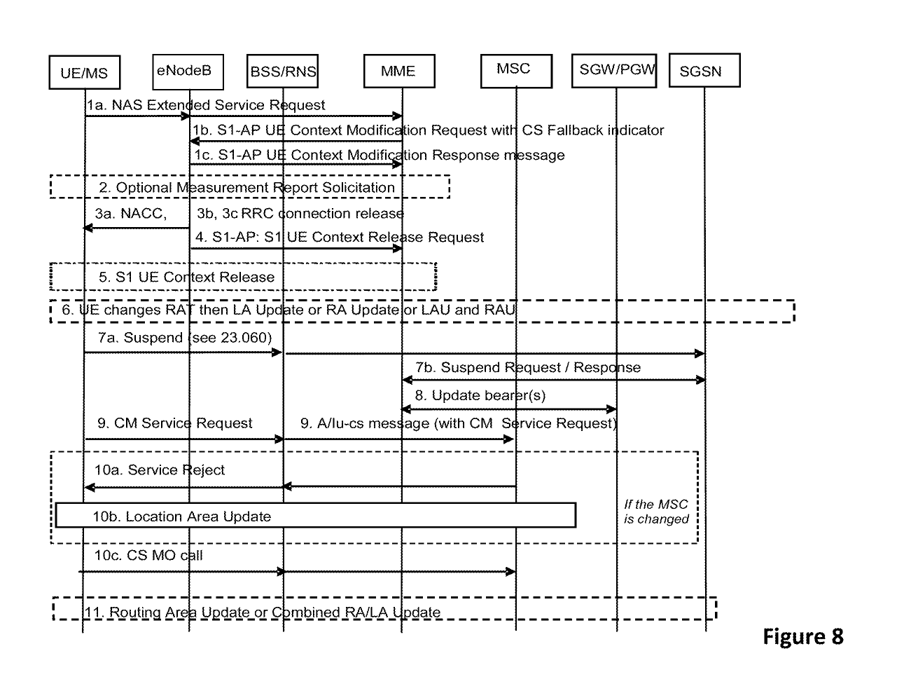

FIG. 6 illustrates a function block diagram of an example UE 12 for implementing CSFB to a GERAN/UTRAN target cell shared by multiple PLMNs 1-N including, for example, the UE procedures described above in FIG. 3 and the UE procedures illustrated in FIGS. 8-10 and described below. The UE 12 includes a controller 30 coupled to one or more user interfaces 36 (e.g., keypad, microphone, speaker, display, etc.), and radio circuitry 38. The controller includes a message generator 32 for generating messages relating to call setup, CSFB, measurements, etc., and a network selector 34 for analyzing one or more messages to identify and decode preferred mobile network identifier information that may be used to trigger establishment of a circuit switched call connection for the UE in a target CSFB cell and if needed determine whether a LAU procedure is needed. The radio circuitry 38, which is under the control of the controller 30, may include functionality and hardware to communicate over a radio interface using different radio access technologies 40, 42.

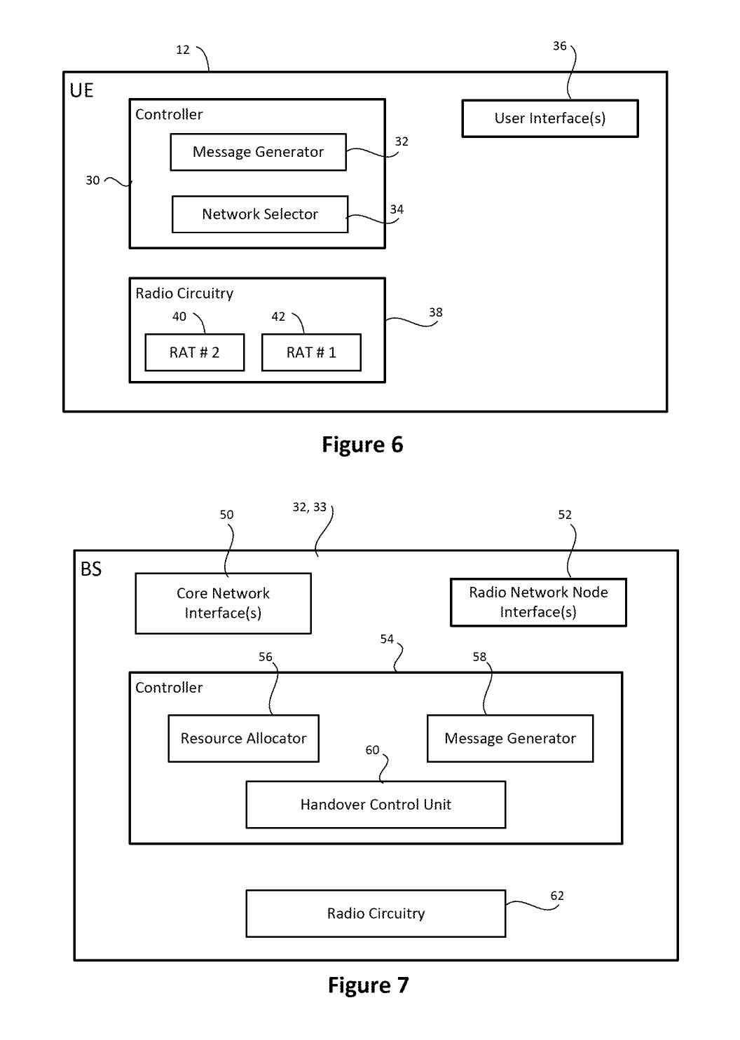

FIG. 7 illustrates a function block diagram of an example radio network node, e.g., a radio base station (BS) such as the source node 14 and the target node 16 for implementing CSFB to a GERAN/UTRAN target cell shared by multiple PLMNs 1-N. The BS includes one or more core network interface(s) 50 for communication with core network nodes, such as MSCs 22, and one or more radio network node interface(s) 52 for communication with RAN nodes like other BSs and/or radio network controllers (RNCs). A controller 54 controls the overall operation of the BS and also includes a resource allocator 56, e.g., a scheduler, a message generator 58 for generating messages relating to call setup and CSFB, and a handover control unit 60 for assisting for example in PS HO or RWR. The BS also includes radio circuitry 62 for communicating with one or more UEs over the radio interface.

One aspect of example embodiments provides a UE with PLMN index information as part of PS HO based CSFB to allow the UE to send Non-access Stratum (NAS) messages (e.g., a LAU or CM Service Request message) that include the PLMN Index information, and thereby allow the radio network node controlling the CSFB target cell to direct NAS messages (received from the UE in the target CSFB cell) to the intended core network. The PLMN index information refers to either the common PLMN described in the background or a specific different PLMN that shares the radio network node. As a result, the shared radio network node can route the NAS message to the corresponding core network associated with the PLMN index information.

Another aspect of example embodiments provides a UE with additional shared PLMNs information as part of a PS Handover command sent to the UE for PS HO-based CSFB together with PLMN Index information so that the UE can determine a specific PLMN selected for it to use by the MME. As a result, the UE can accurately determine if it needs to perform a LAU upon arriving in the target CSFB cell, and if desired, to inform the UE user of the PLMN being used in the target CSFB cell. Alternatively, the UE can be provided with a “LAU Needed” flag together with PLMN Index information as part of PS HO based CSFB to allow the UE to determine if a LAU is needed in the target CSFB cell upon arriving in the target cell. Similarly, the UE can be provided with network identifier information specific to the mobile network operator corresponding to the PLMN selected by the MME during the CSFB procedure together with PLMN Index information as part of PS Handover-based CSFB. If a LAU is needed, then the UE uses the PLMN Index information to direct the LAU to the intended core network by including the PLMN Index information in the LAU Request. For the RWR-based CSFB procedure, the UE can be provided with this same information within the Radio Resource Control (RRC) Connection Release message.

Non-limiting example embodiments described below provide a UE with preferred mobile network identifier information that indicates one or more of the “additional shared PLMNs.” One example embodiment describes providing the UE with information regarding the full set of PLMNs sharing the target cell(s) on the source side, denoted as “Shared PLMN info from the source side.” Another example embodiment provides the UE with information about the full set of PLMNs sharing the target cell(s) on the target side, denoted as “Shared PLMN info from the target side.” Another example embodiment describes providing the UE with information regarding the specific PLMN selected by the MME for the UE to use in the sharing the target cell(s) on the source side, denoted as “Specific Shared PLMN info from the source side.” Yet another example embodiment provides a UE with a “LAU Needed” flag or other indicator denoted as a “LAU needed indication.”

FIG. 8-10 illustrates signaling diagrams for CSFB to a GERAN/UTRAN to its target cell shared by multiple PLMNs 1-N in accordance with non-limiting, example embodiments. These embodiments use specific signaling, messages, and types of information compatible with 3GPP specifications for ease of description, but the technology is not limited to these examples.

The Shared PLMN Info from source example embodiment provides a UE involved with a CSFB service with information regarding what PLMN(s) are sharing the target cell from the source side. One example implementation adds GERAN System Information Type 16 and Type 17 to the set of the system information provided to the UE during the CSFB procedure from the source side. A non-limiting detailed example is described below for the case of the MO Call for MS in Active Moded—no PS HO support, see 3GPP TS 23.272 clause 6.3, in conjunction with the example signaling diagram shown in FIG. 8. This example implementation is integrated in messaging steps where the source eNB provisions the UE with additional information regarding PLMNs sharing one or more target cell(s). This example signaling procedure may be executed when PS HO is not supported. 3GPP TS 23.272 clause 6.6 describes the procedure when the procedure is rejected by the MME.

The scenario is a CS Call Request in E-UTRAN with the call implemented via GERAN/UTRAN. Note that Dual Transfer Mode (DTM) refers to the UE ability to operate a CS service and PS service in parallel and is not mandatory for CS Fallback to work and is not linked to PS HO. A UE operating only a CS service is said to be in “dedicated” mode. Each numbered signaling message in FIG. 8 is now described.
1a. The UE sends an Extended Service Request for mobile originating CS fallback to the MME. Extended Service Request message is encapsulated in RRC and S1-AP messages. The UE only transmits this request if it is attached to CS domain (with a combined EPS/IMSI Attach) and can not initiate an IMS voice session (because e.g. the UE is not IMS registered or IMS voice services are not supported by the serving IP-CAN, home PLMN or UE).
1b. The MME sends an S1-AP UE Context Modification Request (CS Fallback Indicator, LAI) message to eNodeB. This message indicates to the eNodeB that the UE should be moved to UTRAN/GERAN. The registered PLMN for CS domain is identified by the PLMN ID included in the LAI, which is allocated by the MME.
   If MME determines the CS Fallback procedure needs priority handling based on MPS CS Priority in the UE's EPS subscription, it sets priority indication, i.e. “CSFB High Priority”, in the SlAP message to the eNodeB as specified in TS 36.413.
1c. The eNodeB shall reply with S1-AP UE Context Modification Response message.
2. The eNodeB may optionally solicit a measurement report from the UE to determine the target GERAN/UTRAN cell to which the redirection procedure will be performed.
The network performs one of steps 3a or 3b or 3c.
3a. If the UE and network support an inter-RAT cell change order to GERAN and the target cell is GERAN:
   The eNodeB can trigger an inter-RAT cell change order (optionally with NACC) to a GERAN neighbour cell by sending an RRC message to the UE. The inter-RAT cell change order may contain a CS Fallback Indicator which indicates to UE that the cell change order is triggered due to a CS fallback request. In addition, for the case where the target CSFB cell supports FULL-MOCN operation, the cell change order may contain mobile network identifier information corresponding to the preferred mobile network intended to serve the UE in the target CSFB cell (i.e., mobile network operator index information as well as information that allows the UE to determine if the UE needs to perform a LAU upon arrival in the target CSFB cell). If the inter-RAT cell change order contains a CS Fallback Indicator and the UE fails to establish connection to the target RAT, then the UE considers that CS fallback has failed. Service Request procedure is considered to be successfully completed when cell change order procedure is completed successfully.
   The eNodeB selects the target cell considering the PLMN ID and possibly the LAC for CS domain provided by the MME in step 1b for CCO/NACC purpose.
3b. If the UE or the network does not support inter-RAT PS handover from E-UTRAN to GERAN/UTRAN nor inter-RAT cell change order to GERAN or the network does not wish to use these procedures:
   The eNodeB can trigger RRC connection release with redirection to GERAN or UTRAN. In addition, for the case where the target CSFB cell supports FULL-MOCN operation, the RRC connection release with redirection order may contain mobile network identifier information corresponding to the preferred mobile network intended to serve the UE in the target CSFB cell (i.e. mobile network operator index information as well as information that allows the UE to determine if the UE needs to perform a LAU upon arrival in the target CSFB cell).
NOTE 1: When performing CS Fallback to UTRAN, the RRC connection release with redirection can be optimized if both the UE and UTRAN support the optional “Deferred measurement control reading” feature specified in TS 25.331[7].
3c. If the UE and network support “RRC connection release with redirection and Multi Cell System Information to GERAN/UTRAN,” then the eNodeB can trigger RRC connection release with redirection to GERAN or UTRAN and include one or more physical cell identities and their associated System Information. In step 3b or step 3c, the eNodeB includes the redirection control information into the RRC Connection Release message based on the PLMN ID for CS domain and the RAT/frequency priority configured in the eNodeB, so that the UE registered PLMN for CS domain can be preferably selected. In addition, for the case where the target cell supports FULL-MOCN operation, the RRC connection release with redirection order may contain mobile network identifier information corresponding to the preferred mobile network intended to serve the UE in the target cell (i.e. mobile network operator index information as well as information that allows the UE to determine if it needs to first perform a LAU upon arrival in the target cell).
NOTE 2: Service Request procedure supervision timer is sufficiently long considering the optional measurement reporting at step 2.
4. The eNodeB sends an S1-AP UE Context Release Request message to the MME. If the target cell is GERAN and either the target cell or the UE does not support DTM the message includes an indication that the UE is not available for the PS service.
5. The MME releases the UE Context in the eNodeB as well as all eNodeB related information in the S-GW as specified in TS 23.401.
   In case the Cause indicates that RRC was released due to abnormal conditions, e.g. radio link failure, the MME suspends the EPS bearers (Step 8).
The UE performs one of steps 6a or 6b or 6c and then performs step 6d.
6a. (Step 6a is performed if step 3a, Cell Change Order to GERAN, was performed)
   The UE moves to the new cell in GERAN. The UE uses the NACC information and/or the broadcast System Information and when it has all of the necessary information to access the GERAN cell, establishes a radio signalling connection.
6b. (Step 6b is performed if step 3b, RRC release with redirection, was performed).
   The UE moves to the target RAT, identifies a suitable cell preferably of the same PLMN as received in LAI IE of combined EPS/IMSI Attach/TAU Accept message, receives the broadcast System Information and when it has the necessary information to access GERAN/UTRAN, establishes a radio signalling connection.
6c. (Step 6c is performed if step 3c, RRC connection release with redirection and Multi Cell System Information, was performed).
   The UE moves to the target RAT and identifies a suitable cell preferably of the same PLMN as received in LAI IE of combined EPS/IMSI Attach/TAU Accept message. The UE uses the Multi Cell System Information and/or the broadcast System Information and when it has all of the necessary information to access GERAN/UTRAN, the UE establishes the radio signalling connection.
6d. When the UE arrives at the target cell, if target RAT is UTRAN: The UE establishes the radio signalling connection by sending an RRC Initial Direct Transfer message as specified in TS 25.331 that contains a NAS message. The CN Domain Indicator is set to “CS” in the Initial Direct Transfer message.
   If target RAT is GERAN A/Gb mode: The UE establishes a radio signalling connection by using the procedures specified in TS 44.018[4] (i.e. UE requests and is assigned a dedicated channel where it sends a SABM containing a NAS message to the BSS and the BSS responds by sending a UA). Upon receiving the SABM (containing the NAS message) the BSS sends a COMPLETE LAYER 3 INFORMATION message (containing the NAS message) to the MSC which indicates CS resources have been allocated in the GERAN cell. After the establishment of the main signalling link as described in TS 44.018 the UE enters either Dual Transfer Mode or Dedicated Mode.
   If the LA of the new cell is different from the one stored in the UE, the UE shall initiate a Location Area Update regardless of the different Network Modes of Operation (NMO). The UE shall set the “follow-on request” flag in the LAU Request in order to indicate to the MSC not to release the Iu/A connection after the LAU procedure is complete. The UE shall indicate to the target MSC that this is an originating call establishment as a result of CSFB by including the CSMO flag. Further the UE performs any Routing Area Update procedure as specified by TS 23.060 [3].
   In NMO I a CSFB UE shall perform separate LAU with “follow-on request” flag and “CSMO” flag, and RAU procedures instead of a Combined RA/LA Update procedure to speed up the CSFB procedure.
7. If the target RAT is GERAN and DTM is not supported or the UE does not support DTM, the UE starts the Suspend procedure specified in TS 23.060. This triggers the (serving) SGSN to send a Suspend Request (TLLI, RAI) message to the old CN node identified by the RAI and TLLI. If ISR is not active, the RAI and TLLI refer to an MME. The MME returns a Suspend Response to the SGSN even though the GUTI cannot be derived from the P-TMSI and RAI pair. If ISR is active, the RAI and TLLI refer to the old S4-SGSN, In this case, if the serving SGSN is different from the old SGSN which has ISR association with MME, the old SGSN returns a Suspend Response to the serving SGSN.
NOTE 3: For step 7b and 8, the inter-SGSN suspending procedure of ISR active case are not shown in the figure.
8. If the S1-AP UE Context Release Request message, received from the eNodeB in step 4, indicates that the UE is not available for the PS service in the target cell, the MME deactivates GBR bearers towards S-GW and P-GW(s) by initiating MME-initiated Dedicated Bearer Deactivation procedure as specified in TS 23.401, and starts the preservation and suspension of non-GBR bearers by sending Suspend Notification message to the S-GW. If ISR is active, the (old) S4-SGSN deactivates GBR bearers towards S-GW and P-GW(s) by initiating MS- and SGSN initiated Bearer Deactivation procedure as specified in TS 23.060, and starts the preservation and suspension of non-GBR bearers by sending the Suspend Notification message to the S-GW, which is all triggered by the Suspend procedure in step 7. The S-GW sends Suspend Notification message to the P-GW(s) when it receives the Suspend Notification message from MME or S4-SGSN. If the S-GW receives two Suspend Notification messages for the same UE, it ignores the second one except for sending response. The MME stores in the UE context that UE is suspended status. If ISR is active, the (old) S4-SGSN stores in the UE context that UE is in suspended status. All the preserved non-GBR bearers are marked as suspended status in the S-GW and P-GW(s). The P-GW should discard packets if received for the suspended UE.
NOTE 4: Step 8 can not be triggered by the Suspend procedure since the full GUTI can not be derived from the P-TMSI and RAI included in the Suspend Request message.
9. The UE continues with the MO call setup procedure with sending CM Service Request. The UE shall indicate to the MSC that this is an originating call establishment as a result of CSFB by including the “CSMO” flag. For the case where the cell change order of step 3a, 3b, or 3c provides the UE with mobile network identifier information corresponding to the preferred mobile network intended to serve the UE in the target cell, the UE includes the mobile network operator index information within the CM Service Request message thereby allowing the target BSS to direct the CM Service Request to the preferred MSC.
10a. If the UE is not registered in the MSC serving the 2G/3G cell or the UE is not allowed in the LA, the MSC shall reject the service request, if implicit location update is not performed.
10b. A UE detecting that the MSC rejected the service request shall perform the Location Area Update or a Combined RA/LA procedure according to existing GERAN or UTRAN procedures as specified in TS 23.060 for the different Network Modes of Operation (NMO). For the case where the cell change order of step 3a, 3b, or 3c provides the UE with mobile network identifier information corresponding to the preferred mobile network intended to serve the UE in the target CSFB cell, the UE includes the mobile network operator index information within the LAU Request/Combined LAU Request message thereby allowing the target BSS to direct the LAU to the preferred MSC.
10c. The UE initiates the CS call establishment procedure and the UE shall include the CSMO flag in the CM Service Request to the MSC. For the case where the cell change order of step 3a, 3b or 3c provides the UE with mobile network identifier information corresponding to the preferred mobile network intended to serve the UE in the target CSFB cell, the UE includes the mobile network operator index information within the CM Service Request message thereby allowing the target BSS to direct the CM Service Request to the preferred MSC.
11. After the CS voice call is terminated and if the UE is in GERAN and PS services are suspended, then the UE shall resume PS services as specified in TS 23.060. A Gn/Gp-SGSN will follow TS 23.060 to resume the PDP Context(s); in addition, the Gn/Gp SGSN sends a Update PDP Context Request message to the GGSN/P-GW, the GGSN/P-GW resumes the PDP Context(s). An S4 SGSN will follow TS 23.060 to resume the bearers, and informs the S-GW and P-GW(s) to resume the suspended bearers. If the UE has returned to E-UTRAN after the CS voice call was terminated, then the UE shall resume PS service by sending TAU to MME. The MME will in addition inform S-GW and P-GW(s) to resume the suspended bearers. Resuming the suspended bearers in the S-GW and in the P-GW should be done by implicit resume using the Modify Bearer request message if it is triggered by the procedure in operation, e.g. RAU, TAU or Service Request. The S-GW is aware of the suspend state of the bearers and will forward the Modify Bearer request to the P-GW. Explicit resume using the Resume Notification message should be used in cases when Modify Bearer Request is not triggered by the procedure in operation.

If the UE remains on UTRAN/GERAN after the CS voice call is terminated, then the UE performs normal mobility management procedures as defined in TS 23.060 and TS 24.008.

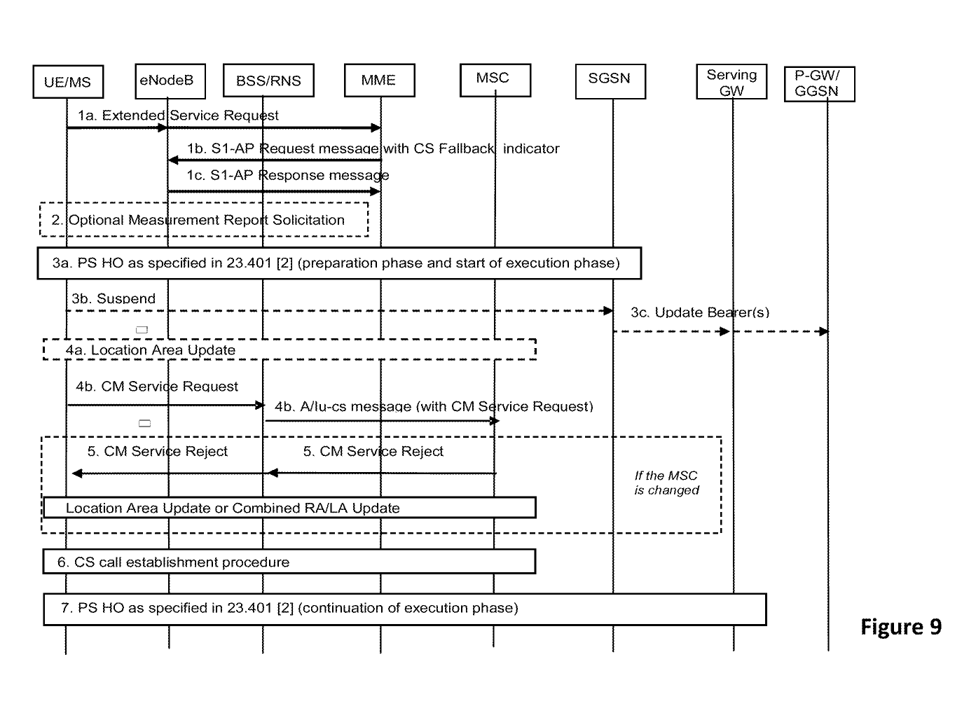

Another example implementation is provided for the case of a MO Call for MS in Active Moded—PS HO support, see 3GPP TS 23.272, clause 6.2, and now described in conjunction with the signaling diagram of FIG. 9. The example implementation is integrated into the step 3, where the source eNB provisions the UE with the additional information regarding PLMNs sharing the target cell(s). This example signaling flow may be executed when the eNodeB knows that both the UE and the network support PS HO, in the normal case. Clause 6.6 describes the procedure when the procedure is rejected by the MME.
NOTE 1: DTM is not mandatory for CS Fallback to work and is not linked to PS HO.
1a. The UE sends an Extended Service Request for mobile originating CS fallback to MME. Extended Service Request message is encapsulated in RRC and S1-AP messages. The UE only transmits this request if it is attached to CS domain (with a combined EPS/IMSI Attach) and can not initiate an IMS voice session (because e.g. the UE is not IMS registered or IMS voice services are not supported by the serving IP-CAN, home PLMN or UE).
1b. The MME sends an S1-AP UE Context Modification Request (CS Fallback Indicator, LAI) message to eNodeB. This message indicates to the eNodeB that the UE should be moved to UTRAN/GERAN. The registered PLMN for CS domain is identified by the PLMN ID included in the LAI, which is allocated by the MME.
   If MME determines the CS Fallback procedure needs priority handling based on MPS CS Priority in the UE's EPS subscription, it also sets priority indication, i.e. “CSFB High Priority”, in the SlAP message to the eNodeB as specified in TS 36.413[35].
1c. The eNodeB shall reply with S1-AP UE Context Modification Response message.
2. The eNodeB may optionally solicit a measurement report from the UE to determine the target GERAN/UTRAN cell to which PS handover will be performed.
NOTE 1: Based on operator policy, the priority indicator received in step 1b may be used by eNodeB to decide whether to continue CS Fallback procedures with PS HO, i.e. step 3a, or to initiate radio release procedure to redirect the UE to 2G/3G Circuit Switch as specified in clause 6.3.
3a. The eNodeB triggers PS handover to a GERAN/UTRAN neighbour cell by sending a Handover Required message to the MME. The eNodeB selects the target PS handover cell considering the PLMN ID and possibly the LAC for CS domain provided by the MME in step 1b.
   If the eNB is a HeNB, the HeNB should perform step 3 through step 6 of clause 6.3 instead of PS HO if the HeNB detects that the UE has only LIPA PDN Connections. CSFB will not be completed successfully when PS HO is performed if the UE has only LIPA PDN Connections as PS HO would result in the MME detaching the UE.
NOTE 2: For details how the HeNodeB determines whether a PDN connection is a LIPA PDN connection, see TS 23.401, clause 4.3.16.
   In the following an inter-RAT handover from E-UTRAN to UTRAN or GERAN as specified in TS 23.401 begins. The eNodeB indicates in the Source RNC to Target RNC Transparent container that PS handover was triggered due to CSFB. The eNodeB also indicates whether CSFB was triggered for emergency or priority call handling purpose. If the network supports a priority call handling, the eNodeB may forward the priority indication to the target GERAN/UTRAN in the Source to Target Transparent Container, and the target GERAN/UTRAN allocates radio bearer resources taking received priority indication take into account. As part of this handover, the UE receives a HO from E-UTRAN Command and tries to connect to a cell in the target RAT. The HO from E-UTRAN Command may contain a CS Fallback Indicator which indicates to UE that the handover is triggered due to a CS fallback request. In addition, for the case where the target cell supports FULL-MOCN operation, the HO from E-UTRAN Command may contain mobile network identifier information corresponding to the preferred mobile network intended to serve the UE in the target CSFB cell (i.e., mobile network operator index information as well as information that allows the UE to determine if it needs to perform a LAU upon arrival in the target CSFB cell). If the HO from E-UTRAN Command contains a CS Fallback Indicator and the UE fails to establish connection to the target RAT, then the UE considers that CS fallback has failed. Service Request procedure is considered to be successfully completed when PS Handover procedure is completed successfully.
NOTE 3: During the PS HO the SGSN does not create a Gs association with the MSC/VLR.
NOTE 4: Service Request procedure supervision timer shall be sufficiently long considering the optional measurement reporting at step 2.
   When the UE arrives at the target cell, if the target RAT is UTRAN, the UE establishes the radio signalling connection by sending an RRC Initial Direct Transfer message as specified in TS 25.331 that contains a NAS message. The CN Domain Indicator is set to “CS” in the Initial Direct Transfer message.
   If the target RAT is GERAN A/Gb mode: The UE establishes a radio signalling connection by using the procedures specified in TS 44.018 (i.e. UE requests and is assigned a dedicated channel where it sends a SABM containing a NAS message to the BSS and the BSS responds by sending a UA). Upon receiving the SABM (containing the NAS message) the BSS sends a COMPLETE LAYER 3 INFORMATION message (containing the NAS message) to the MSC which indicates CS resources have been allocated in the GERAN cell. If both the UE and the target cell support enhanced CS establishment in DTM (indicated by GERAN system information included within the HO from E-UTRAN Command) a RR connection may be established while in packet transfer mode without release of the packet resources, see TS 43.055. After the establishment of the main signalling link as described in TS 44.018 the UE enters either Dual Transfer Mode or Dedicated Mode.
3b. If the target RAT is GERAN and the UE has entered Dedicated Mode, the UE starts the Suspend procedure (see TS 44.018) unless both the UE and the Target cell support DTM in which case TBF re-establishment may be performed.
3c. A Gn/Gp-SGSN that receives the Suspend message from the UE follows the Suspend procedure specified in TS 23.060, clause 16.2.1.1.1.
   An S4-SGSN that receives the Suspend message from the UE follows the Suspend procedure specified in TS 23.060. The S4-SGSN deactivates GBR bearers towards S-GW and P-GW(s) by initiating MS- and SGSN Initiated Bearer Deactivation procedure as specified in TS 23.060, and starts the preservation and suspension of non-GBR bearers by sending Suspend Notification message to the S-GW. The S-GW releases all RNC related information (address and TEIDs) for the UE if Direct Tunnel is established, and sends Suspend Notification message to the P-GW(s). The SGSN stores in the UE context that UE is in suspended status. All the preserved non-GBR bearers are marked as suspended status in the S-GW and P-GW(s). The P-GW should discard packets if received for the suspended UE.
4a. If the LA of the new cell is different from the one stored in the UE, the UE shall initiate a Location Area Update procedure as follows:
   if the network is operating in NMO-I (Network Modes of Operation), the UE shall initiate a separate Location Area Update before initiating the RAU procedure instead of a Combined RA/LA Update procedure (to speed up the CSFB procedure); or
   if the network is operating in NMO-II or NMO-III, the UE shall initiate a Location Area Update before initiating the RAU procedure required for PS handover.
   When the UE initiates a Location Area Update the UE shall set the “follow-on request” flag in the LAU Request in order to indicate to the MSC not to release the Iu/A connection after the LAU procedure completion. The UE shall indicate to the target MSC that this is an originating call establishment as a result of CSFB by including the “CSMO” flag. Further the UE performs any Routing Area Update procedure as specified by TS 23.060. For the case where the HO from E-UTRAN Command of step 3a provides the UE with mobile network identifier information corresponding to the preferred mobile network intended to serve the UE in the target CSFB cell, the UE includes the mobile network operator index information within the LAU Request/Combined LAU Request message thereby allowing the target CSFB BSS to direct the LAU to the preferred MSC.
   The UE may initiate a Location Area Update procedure immediately when the UE is handed over to the target cell i.e. before the UE receives e.g. LAI or NMO information as part of the RAN Mobility Information.
4b. The UE sends a CM Service Request to the MSC. The UE shall indicate to the MSC that this is an originating call establishment as a result of CSFB by including the “CSMO” flag. For the case where the HO from E-UTRAN Command of step 3a provides the UE with mobile network identifier information corresponding to the preferred mobile network intended to serve the UE in the target CSFB cell, the UE includes the mobile network operator index information within the CM Service Request message thereby allowing the target CSFB BSS to direct the CM Service Request to the preferred MSC.
5. If the UE is not registered in the MSC serving the 2G/3G target cell or the UE is not allowed in the LA, the MSC shall reject the CM service request, if implicit location update is not performed. The CM Service Reject shall trigger the UE to perform a Location Area Update or a Combined RA/LA Update procedure as specified in TS 23.060 [3] for the different Network Modes of Operation (NMO). For the case where the HO from E-UTRAN Command of step 3a provides the UE with mobile network identifier information corresponding to the preferred mobile network intended to serve the UE in the target CSFB cell, the UE includes the mobile network operator index information within the LAU Request/Combined LAU Request message thereby allowing the target CSFB BSS to direct the LAU to the preferred MSC.
6. The UE initiates the CS call establishment procedure and the UE shall include the CSMO flag in the CM Service Request to the MSC. For the case where the HO from E-UTRAN Command of step 3a provides the UE with mobile network identifier information corresponding to the preferred mobile network intended to serve the UE in the target CSFB cell, the UE includes the mobile network operator index information within the CM Service Request message thereby allowing the target BSS to direct the CM Service Request to the preferred MSC.
7. The UE performs any remaining steps of the inter-RAT handover from E-UTRAN to UTRAN or GERAN as specified in TS 23.401.

If the UE remains on UTRAN/GERAN after the CS voice call is terminated the UE performs normal mobility management procedures as defined in TS 23.060 and TS 24.008.

Another non-limiting example implementation provides a UE that is subject to CSFB with the information regarding what PLMN(s) are sharing the CSFB target cell from the target side. This may be achieved by requiring a UE that receives in the SI3 message (for PS Handover based CSFB) or in Radio Resource Control (RRC) Connection Release message (for RWR based CSFB) the indication that the target cell supports FULL-MOCN to indicate, upon arrival in the CSFB target cell, to the radio network node controlling the CSFB target cell a request for SI16&17 either in the CS-domain, step 6 or 7a in the example MO Call for MS in Active Mode—no PS HO support in FIG. 8, see 3GPP TS 23.272 clause 6.3 or in the PS-domain, step 3a or 3b in the example MO Call for MS in Active Mode—PS HO support in FIG. 9, see 3GPP TS 23.272 clause 6.2. The radio network node responds to such a request with the SI16&17 on the DCCH when in the CS domain or on the PACCH when in the PS domain.

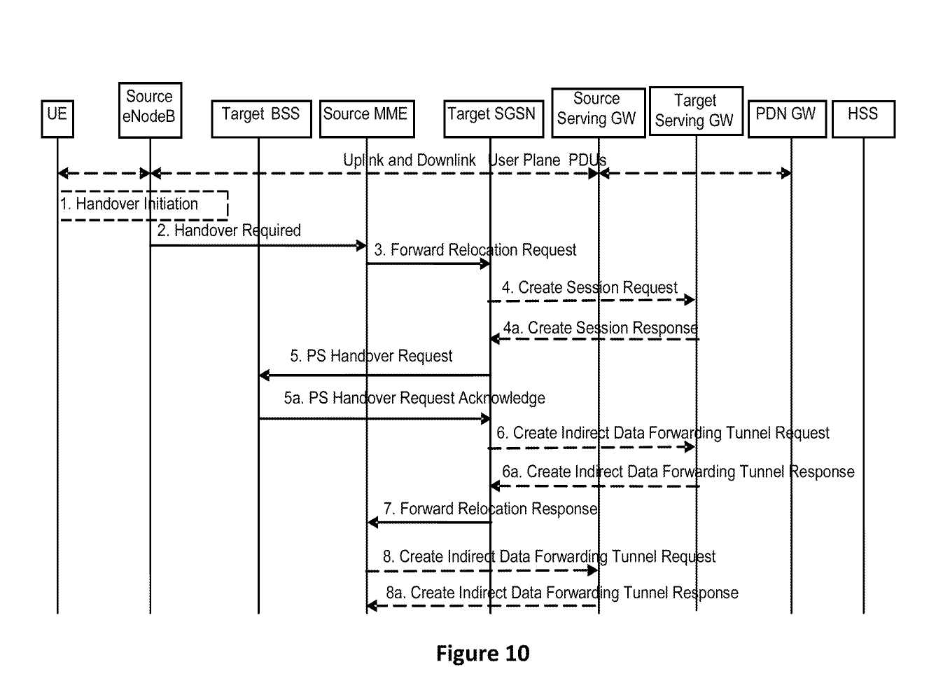

The next example implementation is directed to a case where PS HO is supported and introduces a flag to indicate whether a LAU is needed or not for the UE involved in a CSFB procedure. The flag is denoted as LAU NEEDED and may be set by the source MME during the Inter RAT PS Handover preparation phase in the Forward Relocation Request message when the target PLMN is different from the registered PLMN. The LAU NEEDED flag is forwarded to the target CSFB radio network node and included by the target CSFB BSS in the 3GPP TS 44.060 (clause 11.2.43) PS HANDOVER COMMAND message that is sent back to the source radio network node in the 3GPP TS 48.018 (clause 8a.5) PS HANDOVER REQUEST ACK message. Finally, the 3GPP TS 44.060 (clause 11.2.43) PS HANDOVER COMMAND message is sent to the MS as part of the MobilityFromEUTRACommand in E-UTRAN as specified in 3GPP TS 36.331 (clause 5.4.3.3). This example implementation is explained in conjunction with the example signal diagram shown in FIG. 10 using the signaling flows from the 3GPP TS 23.401 subclause 5.5.2.3 E-UTRAN to GERAN A/Gb mode Inter RAT handover as referenced in step 3a of the MO Call for MS in Active Moded—PS HO support in FIG. 9, see 3GPP TS 23.272 clause 6.2.
1. The source eNodeB decides to initiate an Inter RAT Handover to the target GERAN A/Gb mode (2G) system. At this point both uplink and downlink user data is transmitted via the following: Bearer(s) between UE and Source eNodeB, GTP tunnel(s) between Source eNodeB, Serving GW and PDN GW.
   If the UE has an ongoing emergency bearer service the source eNodeB shall not initiate PS handover to GERAN.
NOTE 1: The process leading to the handover decision is outside of the scope of this specification
2. The source eNodeB sends a Handover Required (S1AP Cause, Target System Identifier, Source to Target Transparent Container) message to the Source MME to request the CN to establish resources in the Target BSS, Target SGSN and the Serving GW. The bearers that will be subject to data forwarding (if any) are identified by the target SGSN in a later step (see step 7 below).
The ‘Target System Identifier’ IE contains the identity of the target global cell Id.
3. The Source MME determines from the ‘Target System Identifier’ IE that the type of handover is IRAT Handover to GERAN A/Gb mode. The Source MME initiates the Handover resource allocation procedure by sending a Forward Relocation Request (IMSI, Target Identification (shall be set to “empty”), MM Context, PDN Connections, MME Tunnel Endpoint Identifier for Control Plane, MME Address for Control plane, Source to Target Transparent Container, Packet Flow ID, XID parameters (if available), Target Cell Identification, MS Info Change Reporting Action (if available), CSG Information Reporting Action (if available), UE Time Zone, ISR Supported, RAN Cause, Serving Network) message to the target SGSN. If the information ISR Supported is indicated, this indicates that the source MME and associated Serving GW are capable to activate ISR for the UE. When ISR is activated the message should be sent to the SGSN that maintains ISR for the UE when this SGSN is serving the target identified by the Target Identification. This message includes all PDN Connections active in the source system and for each PDN Connection includes the associated APN, the address and the uplink Tunnel endpoint parameters of the Serving GW for control plane, and a list of EPS Bearer Contexts. The old Serving Network is sent to target MME to support the target MME to resolve if Serving Network is changed. In network sharing scenarios Serving Network denotes the serving core network.
   The target SGSN maps the EPS bearers to PDP contexts 1-to-1 and maps the EPS Bearer QoS parameter values of an EPS bearer to the Release 99 QoS parameter values of a bearer context as defined in Annex E.
   Prioritization of PDP Contexts is performed by the target core network node, i.e. target SGSN.
   If the Source MME supports IRAT Handover to GERAN A/Gb procedure it has to allocate a valid PH during the bearer activation procedure. RAN Cause indicates the SlAP Cause as received from the source eNodeB. The Source to Target Transparent Container includes the value from the Source to Target Transparent Container received from the source eNodeB.
   The MM context contains security related information, e.g. supported ciphering algorithms, as described in TS 29.274. Handling of security keys is described in TS 33.401.
   The target SGSN selects the ciphering algorithm to use. This algorithm will be sent transparently from the target SGSN to the UE in the NAS container for Handover (part of the Target to Source Transparent Container). The IOV-UI parameter, generated in the target SGSN, is used as input to the ciphering procedure and it will also be transferred transparently from the target SGSN to the UE in the NAS container for Handover. More details are described in TS 33.401.
   When the target SGSN receives the Forward Relocation Request message the required EPS Bearer, MM, SNDCP and LLC contexts are established and a new P-TMSI is allocated for the UE. When this message is received by the target SGSN, it begins the process of establishing PFCs for all EPS Bearer contexts.
   When the target SGSN receives the Forward Relocation Request message it extracts from the EPS Bearer Contexts the NSAPIs and SAPIs and PFIs to be used in the target SGSN. If for a given EPS Bearer Context the target SGSN does not receive a PFI from the source MME, it shall not request the target BSS to allocate TBF resources corresponding to that EPS Bearer Context. If none of the EPS Bearer Contexts forwarded from the source MME has a valid PFI allocated the target SGSN shall consider this as a failure case and the request for Handover shall be rejected.
   If when an SAPI and PFI was available at the source MME but the target SGSN does not support the same SAPI and PFI for a certain NSAPI as the source MME, the target SGSN shall continue the Handover procedure only for those NSAPIs for which it can support the same PFI and SAPI as the source MME. All EPS Bearer contexts for which no resources are allocated by the target SGSN or for which it cannot support the same SAPI and PFI (i.e. the corresponding NSAPIs are not addressed in the response message of the target SGSN), are maintained and the related SAPIs and PFIs are kept. These EPS Bearer contexts may be modified or deactivated by the target SGSN via explicit SM procedures upon RAU procedure.
   The source MME shall indicate the current XID parameter settings if available (i.e. those XID parameters received during a previous IRAT Handover procedure) to the target SGSN. If the target SGSN can accept all XID parameters as indicated by the source MME, the target SGSN shall create a NAS container for Handover indicating ‘Reset to the old XID parameters’. Otherwise, if the target SGSN cannot accept all XID parameters indicated by the source MME or if no XID parameters were indicated by the source MME, the target SGSN shall create a NAS container for Handover indicating Reset (i.e. reset to default parameters).
   The target SGSN shall determine the Maximum APN restriction based on the APN Restriction of each bearer context received in the Forward Relocation Request, and shall subsequently store the new Maximum APN restriction value.
   In the case that the target PLMN is different from the registered PLMN, the source MME includes an LAU NEEDED flag in the Forward Relocation request.
4. The target SGSN determines if the Serving GW is to be relocated, e.g., due to PLMN change. If the Serving GW is to be relocated, the target SGSN selects the target Serving GW as described under clause 4.3.8.2 on “Serving GW selection function”, and sends a Create Session Request message (IMSI, SGSN Tunnel Endpoint Identifier for Control Plane, SGSN Address for Control plane, PDN GW address(es) for user plane, PDN GW UL TEID(s) for user plane, PDN GW address(es) for control plane, and PDN GW TEID(s) for control plane, the Protocol Type over S5/S8, Serving Network) per PDN connection to the target Serving GW. The Protocol Type over S5/S8 is provided to Serving GW which protocol should be used over S5/S8 interface.
4a. The target Serving GW allocates its local resources and returns a Create Session Response (Serving GW address(es) for user plane, Serving GW UL TEID(s) for user plane, Serving GW Address for control plane, Serving GW TEID for control plane) message to the target SGSN.
5. The target SGSN establishes the EPS Bearer context(s) in the indicated order. The SGSN deactivates, as provided in step 9 of the execution phase, the EPS Bearer contexts which cannot be established.
   The Target SGSN requests the Target BSS to establish the necessary resources (PFCs) by sending the message PS Handover Request (Local TLLI, IMSI, Cause, Target Cell Identifier, PFCs to be set-up list, Source RNC to Target BSS Transparent Container and NAS container for handover). The target SGSN shall not request resources for which the Activity Status Indicator within a EPS Bearer Context indicates that no active bearer exists on the source side for that PDP context. The Cause indicates the RAN Cause as received from the source MME. The Source RNC to Target BSS Transparent Container contains the value from the Source to Target Transparent Container received from the source MME. All EPS Bearer Contexts indicate active status because E-UTRAN does not support selective RAB handling.
The target SGSN shall forward the LAU NEEDED flag to the target BSS.
   Based upon the ABQP for each PFC the target BSS makes a decision about which PFCs to assign radio resources. The algorithm by which the BSS decides which PFCs that need resources is implementation specific. Due to resource limitations not all downloaded PFCs will necessarily receive resource allocation. The target BSS allocates TBFs for each PFC that it can accommodate.
   The target BSS shall prepare the ‘Target to Source Transparent Container’ which contains a PS Handover Command including the EPC part (NAS container for Handover) and the RN part (Handover Radio Resources).
5a. The Target BSS allocates the requested resources and returns the applicable parameters to the Target SGSN in the message PS Handover Request Acknowledge (Local TLLI, List of set-up PFCs, Target BSS to Source RNC Transparent Container, Cause). Upon sending the PS Handover Request Acknowledge message the target BSS shall be prepared to receive downlink LLC PDUs from the target SGSN for the accepted PFCs.
   Any EPS Bearer contexts for which a PFC was not established are maintained in the target SGSN and the related SAPIs and PFIs are kept. These EPS Bearer contexts shall be deactivated by the target SGSN via explicit SM procedures upon the completion of the routing area update (RAU) procedure.
   For the case where the Target CSFB BSS supports FULL-MOCN operation, the Target CSFB BSS to Source RNC Transparent Container may contain mobile network identifier information corresponding to the preferred mobile network intended to serve the UE in the target CSFB cell (i.e., mobile network operator index information as well as information that allows the UE to determine if it needs to perform a LAU upon arrival in the target cell). When the LAU NEEDED flag is received in the 3GPP TS 48.018 (clause 8a.5) PS HANDOVER REQUEST the Target BSS subsequently includes it in the 3GPP TS 44.060 (clause 11.2.43) PS HANDOVER COMMAND message contained in the 3GPP TS 48.018 (clause 8a.5) PS HANDOVER REQUEST ACK message. The 3GPP TS 44.060 (clause 11.2.43) PS HANDOVER COMMAND message also includes the mobile network operator index information and is sent as part of the Target BSS to Source RNC Transparent Container.
6. If indirect forwarding and relocation of Serving GW applies the target SGSN sends a Create Indirect Data Forwarding Tunnel Request message (Target SGSN Address(es) and TEID(s) for DL data forwarding) to the Serving GW used for indirect packet forwarding.
   Indirect forwarding may be performed via a Serving GW which is different from the Serving GW used as the anchor point for the UE.
6a. The Serving GW returns a Create Indirect Data Forwarding Tunnel Response (Cause, Serving GW DL Address(es) and TEID(s) for data forwarding) message to the target SGSN.
7. The Target SGSN sends the message Forward Relocation Response (Cause, SGSN Tunnel Endpoint Identifier for Control Plane, SGSN Address for Control Plane, Target to Source Transparent Container, RAN Cause, List of set-up PFIs, Address(es) and TEID(s) for User Traffic Data Forwarding, Serving GW change indication) to the Source MME. Serving GW change indication indicates a new Serving GW has been selected. RAN Cause indicates the Cause as received from the target BSS. The Target to Source Transparent Container includes the value from the Target BSS to Source RNC Transparent Container received from the target BSS.
   If ‘Indirect Forwarding’ and relocation of Serving GW applies, then the IEs ‘Address(es) and TEID(s) for User Traffic Data Forwarding’ contain the DL GTP-U tunnel endpoint parameters received in step 6a. Otherwise the IEs ‘Address(es) and TEID(s) for User Traffic Data Forwarding’ contains the DL GTP-U tunnel endpoint parameters to the Target SGSN.
   The target SGSN activates the allocated LLC/SNDCP engines as specified in TS 44.064 for an SGSN originated Reset or ‘Reset to the old XID parameters’.
8. If “Indirect Forwarding” applies, the Source MME sends the message Create Indirect Data Forwarding Tunnel Request (Address(es) and TEID(s) for Data Forwarding (received in step 7)) to the Serving GW used for indirect packet forwarding.
   Indirect forwarding may be performed via a Serving GW which is different from the Serving GW used as the anchor point for the UE.
8a. The Serving GW returns the forwarding user plane parameters by sending the message Create Indirect Data Forwarding Tunnel Response (Cause, Serving GW Address(es) and TEID(s) for Data Forwarding). If the Serving GW doesn't support data forwarding, an appropriate cause value shall be returned and the Serving GW Address(es) and TEID(s) will not be included in the message.

The example embodiments described provide a UE subject to PS HO based CSFB into a GERAN cell that supports FULL/MOCN with information to permit the UE to determine whether a LAU procedure needs to be initiated. This decreases the potential for unnecessary CS call setup delay during a PS HO based CSFB procedure and thus enhances the end/user service perception. According to some embodiments a UE/MS is provided with information, such as a list of shared mobile networks in a target cell or a source cell or a mobile network index or a specific shared mobile network reflecting the PLMN selected by the MME during the PS Handover procedure, enabling the UE/MS to determine whether or not it needs to do a location area update or how to route messages to the correct network. The information provided to the UE/MS may alternatively be a set flag.

The example embodiments described herein may be considered as independent embodiments or may be considered in any combination with each other to describe non-limiting examples.

The technology offers many benefits. For example, the technology provides a UE/MS that is subject to PS HO based CSFB into a GERAN cell that supports FULL/MOCN with information needed by the UE/MS for a decision regarding whether or not a LAU procedure shall be initiated upon arrival in the CSFB target cell. This decreases the potential for unnecessary CS call setup delay during a PS HO based CSFB procedure and thus enhances the end/user service perception.

Although the description above contains many specifics, they should not be construed as limiting but as merely providing illustrations of some presently preferred embodiments. For example, non-limiting, example embodiments of the technology were described in a context with LTE and GERAN/UTRAN technologies. But the principles of the technology described may also be applied to other radio access technologies and other scenarios. Indeed, the technology fully encompasses other embodiments which may become apparent to those skilled in the art. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the described technology for it to be encompassed by the descried technology.

### ABBREVIATIONS

3GPP 3^{rd} Generation Partnership Project
AP Access Preamble
BCCH Broadcast Control CHannel
BSS Base Station Subsystem
CCO Cell Change Order
CM Connection Management
CS Circuit Switched
CSFB CS Fallback
CSMO Circuit Switched fallback Mobile Originated call
DL Downlink
DTM Dual Transfer Mode
eNB eNodeB
EPLMN equivalent PLMN
EPS Evolved Packet System
E-UTRAN evolved UTRAN
FULL-MOCN FULL Multi Operator Core Network
GBR Guaranteed Bit Rate
GERAN GSM/EDGE Radio Access Network
GSM Global System for Mobile Communications
IMS IP Multimedia Subsystem
IMSI International Mobile Subscriber Identity
IP-CAN IP-Connectivity Access Network
LA Location Area
LAC Location Area Code
LAI Location Area Identifier
LAU Location Area Update
MME Mobile Management Entity
MO Mobile Originated
MPS Multimedia Priority Service
MS Mobile Station
MSC Mobile Switching Centre
NACC Network Assisted Cell Change
NAS Non-Access Stratum
NMO Network Modes of Operation
PDP Packet Data Protocol
PLMN Public Land Mobile Network
PS Packet Switched
PSHO PS Handover
P-TMSI Packet TMSI
RA Routing Area
RAI Routing Area Identity
RAN Radio Access Network
RAT Radio Access Technology
RAU Routing Area Update
RNS Radio Network Subsystem
RRC Radio Resource Control
RWR RRC Connection Release With Redirect
SABM Set Asynchronous Balanced Mode
SGSN Serving GPRS Support Node
S-GW Serving Gateway
TLLI Temporary Logical Link Identity
UE User Equipment
UL Uplink
UTRAN Universal Terrestrial Radio Access Network

1. A method for enhancing a circuit-switched call fallback (CSFB) service for a user equipment (UE) currently connected to a source cell in a serving radio access technology (RAT) communications network, where multiple different mobile network operators share a target CSFB cell selected for CSFB from one or more circuit-switched capable cells in a target radio access technology that supports circuit-switched services, each mobile network operator being associated with a corresponding mobile network identifier, the method implemented in the UE and comprising:
transmitting a first message requesting a CSFB service to a source cell radio network node serving the source cell;
receiving from the source cell radio network node, in response to the first message, a second message including preferred mobile network identifier information associated with a preferred mobile network and a target CSFB cell identifier; and
transmitting a third message to a target cell radio network node serving the target CSFB cell to trigger the establishment of a circuit-switched call connection for the UE in the target CSFB cell, the third message including preferred mobile network information to permit the target cell radio network node to direct the third message to a core network node operated by one of the mobile network operators identifiable based on the preferred mobile network information.

2. The method in claim 1, wherein the UE has a registered location area identifier (LAI) different from a LAI corresponding to the preferred mobile network intended to serve the UE in the target RAT communications network that supports circuit-switched services in the one or more circuit-switched capable cells, the method further comprising:
determining, based on the preferred mobile network identifier information, whether a location area update procedure must be performed in the target CSFB cell, and if so, transmitting a fourth message to trigger the location area update procedure.

3. The method in claim 1, wherein the preferred mobile network identifier information includes mobile network operator index information.

4. The method in claim 3, wherein the preferred mobile network identifier information also includes a list of network identifier information for each of the multiple mobile network operators supported in the target cell.

5. The method in claim 3, wherein the preferred mobile network identifier information also includes an indicator indicating whether the UE needs to perform the location area update procedure in the target CSFB cell.

6. The method in claim 3, wherein the preferred mobile network identifier information also includes an indication of a location area identifier (LAI) corresponding to the preferred mobile network.

7. The method in claim 1, wherein the first message is an extended service request message.

8. The method in claim 1, wherein the second message is a cell change message that includes either:
a list of network identifier information for each of the multiple mobile network operators and mobile network operator index information useable by the UE to identify a specific list element and thereby determine whether the UE must perform a location area update procedure in the target cell, or
a flag indicating whether the UE needs to perform a location area update procedure in the target cell, or
an indication of a location area identifier (LAI) corresponding to the preferred mobile network useable by the UE to determine whether to perform a location area update procedure in the target cell.

9. The method in claim 8, wherein the cell change message is a packet-switched handover message or a release with redirect (RWR) message.

10. The method in claim 2, wherein the third and fourth messages include mobile network operator index information.

11. The method in claim 10, wherein the third and fourth messages include mobile network operator index information allowing the target cell radio network node to direct the third and fourth messages to a core network node operated by the preferred mobile network operator.

12. The method in claim 1, wherein the preferred mobile network identifier information received in the second message includes an indicator in a system information message indicating whether the UE needs to perform the location area update procedure in the target CSFB cell, wherein the location area update procedure registers the UE with the LAI corresponding to the preferred mobile network while in the target CSFB cell.

13. A User equipment (UE) apparatus, comprising:
radio circuitry, and
data processing circuitry configured to generate and cause the radio circuitry to transmit a first message requesting a circuit-switched call fallback (CSFB) service to a source cell radio network node serving a source cell in a serving radio access technology communications network;
wherein multiple different mobile network operators share a target CSFB cell selected for CSFB from one or more circuit-switched capable cells in a target radio access technology that supports circuit-switched services, each mobile network operator being associated with a corresponding mobile network identifier;
the radio circuitry configured to receive, in response to the first message, a second message including preferred mobile network identifier information associated with a preferred mobile network; and
the data processing circuitry configured to generate and cause the radio circuitry to transmit a third message for transmission to a target cell radio network node serving the target CSFB cell to trigger the establishment of a circuit-switched call connection for the UE in the target CSFB cell, the third message including preferred mobile network information to permit the target cell radio network node to direct the third message to a core network node operated by one of the mobile network operators identifiable based on the preferred mobile network information.

14. The UE apparatus in claim 13, wherein the UE has a registered location area identifier (LAI) different from an LAI corresponding to the preferred mobile network intended to serve the UE in the target RAT communications network that supports circuit-switched services in the one or more circuit-switched capable cells, and
wherein the data processing circuitry is configured to determine, based on the preferred mobile network identifier information, whether a location area update procedure must be performed in the target CSFB cell, and if so, to cause the radio circuitry to transmit a fourth message to trigger the location area update procedure.

15. The UE apparatus in claim 13, wherein the preferred mobile network identifier information includes mobile network operator index information.

16. The UE apparatus in claim 15, wherein the preferred mobile network identifier information also includes a list of network identifier information for each of the multiple mobile network operators supported in the target cell.

17. The UE apparatus in claim 15, wherein the second message is a system information message that also includes the preferred mobile network identifier information having an indicator indicating whether the UE needs to perform the location area update procedure in the target CSFB cell.

18. The UE apparatus in claim 15, wherein the preferred mobile network identifier information also includes an indication of an LAI corresponding to the preferred mobile network.

19. The UE apparatus in claim 13, wherein the first message is an extended service request message.

20. The UE apparatus in claim 13, wherein the second message is a cell change message that includes either:
a list of network identifier information for each of the multiple mobile network operators and mobile network operator index information useable by the UE to identify a specific list element and thereby determine whether the UE must perform a location area update procedure in the target cell, or
a flag indicating whether the UE needs to perform a location area update procedure in the target cell, or
an indication of a location area identifier (LAI) corresponding to the preferred mobile network useable by the UE to determine whether to perform a location area update procedure in the target cell.

21. The UE apparatus in claim 20, wherein the cell change message is a packet-switched handover message or a release with redirect (RWR) message.

22. The UE apparatus in claim 14, wherein the third and fourth messages include mobile network operator index information.

23. A method for enhancing a circuit-switched call fallback (CSFB) service for a user equipment (UE) currently connected to a source cell in a serving radio access technology communications network, where multiple different mobile network operators share a target CSFB cell selected for CSFB from one or more circuit-switched capable cells in a target radio access technology that supports circuit-switched services, the target CSFB cell being served by a target cell radio network node, each mobile network operator being associated with a corresponding mobile network identifier, the method implemented in a source cell radio network node serving the source cell and comprising:
receiving a first message requesting a CSFB service from the UE; and
transmitting to the UE, in response to the first message, a cell change message including preferred mobile network identifier information associated with a preferred mobile network to trigger establishment of a circuit-switched call connection for the UE in the target CSFB cell.

24. The method in claim 23, wherein the preferred mobile network identifier information includes mobile network operator index information.

25. The method in claim 24, wherein the preferred mobile network identifier information also includes a list of network identifier information for each of the multiple mobile network operators supported in the target cell.

26. The method in claim 24, wherein the preferred mobile network identifier information also includes an indicator indicating whether the UE needs to perform the location area update procedure in the target CSFB cell.

27. The method in claim 24, wherein the preferred mobile network identifier information also includes an indication of a location area indicator (LAI) corresponding to the preferred mobile network.

28. The method in claim 23, wherein the first message is an extended service request message.

29. The method in claim 23, wherein the cell change message includes either:
a list of network identifier information for each of the multiple mobile network operators and mobile network operator index information useable by the UE to identify a specific list element and thereby determine whether the UE must perform a location area update procedure in the target cell, or
a flag indicating whether the UE needs to perform a location area update procedure in the target cell, or
an indication of a location area indicator (LAI) corresponding to the preferred mobile network useable by the UE to determine whether to perform a location area update procedure in the target cell.

30. The method in claim 29, wherein the cell change message is a packet-switched handover message or a release with redirect (RWR) message.

31. A radio network node for serving a source cell in a serving radio access technology communications network, the source cell radio network node comprising:
radio circuitry configured to receive a first message requesting a circuit-switched call fallback (CSFB) service from a user equipment (UE) currently connected to the source cell, where multiple different mobile network operators share a target CSFB cell selected for CSFB from one or more circuit-switched capable cells in a target radio access technology that supports circuit-switched services in one or more circuit-switched capable cells, the target CSFB cell being served by a target cell radio network node, each mobile network operator being associated with a corresponding mobile network identifier; and
data processing circuitry configured, in response to the first message, to generate and cause the radio circuitry to transmit to the UE a cell change message including preferred mobile network identifier information associated with a preferred mobile network to trigger establishment of a circuit-switched call connection for the UE in the target CSFB cell.

32. The radio network node in claim 31, wherein the preferred mobile network identifier information includes mobile network operator index information.

33. The radio network node in claim 32, wherein the preferred mobile network identifier information also includes a list of network identifier information for each of the multiple mobile network operators supported in the target cell.

34. The radio network node in claim 32, wherein the preferred mobile network identifier information also includes an indicator indicating whether the UE needs to perform the location area update procedure in the target CSFB cell.

35. The radio network node in claim 32, wherein the preferred mobile network identifier information also includes an indication of a location area identifier (LAI) corresponding to the preferred mobile network.

36. The radio network node in claim 31, wherein the first message is an extended service request message.

37. The radio network node in claim 31, wherein the cell change message includes either:
a list of network identifier information for each of the multiple mobile network operators and mobile network operator index information useable by the UE to identify a specific list element and thereby determine whether the UE must perform a location area update procedure in the target cell, or
a flag indicating whether the UE needs to perform the location area update procedure in the target cell, or
an indication of a location area identifier (LAI) corresponding to the preferred mobile network useable by the UE to determine whether to perform a location area update procedure in the target cell.

38. The radio network node in claim 37, wherein the cell change message is a packet-switched handover message or a release with redirect (RWR) message.

39. A method for enhancing a circuit-switched call fallback (CSFB) service for a user equipment (UE) requesting a circuit-switched call fallback (CSFB) service in a target CSFB cell in a target radio access technology that supports circuit-switched services, the target CSFB cell being served by a target cell radio network node, each mobile network operator being associated with a corresponding mobile network identifier, the method implemented in the target cell radio network node and comprising:
receiving a message from the UE requesting a CSFB service in the target CSFB cell, where the message includes preferred mobile network identifier information;
sending, based on the preferred mobile network identifier information, the CSFB service request to a core network node identifiable from the preferred mobile network identifier information and associated with one of the multiple different mobile network operators to enable the core network node to initiate the requested CSFB service for the UE; and
assisting in establishing a circuit-switched call connection for the UE in the target CSFB cell in response to sending the core network node a request to initiate the requested CSFB service for the UE.

40. The method in claim 39, wherein the preferred mobile network identifier information includes mobile network operator index information.

41. The method in claim 39, wherein the message is a connection management service request message.

42. A radio network node, comprising:
radio circuitry configured to receive a message indicating that a user equipment (UE) requests a circuit-switched call fallback (CSFB) service in a target cell in a target radio access technology, the message including preferred mobile network identifier information, where multiple different mobile network operators share a target CSFB cell selectable for CSFB from one or more circuit-switched capable cells, the target CSFB cell being served by the radio network node, each mobile network operator being associated with a corresponding mobile network identifier, and
data processing circuitry configured to generate, based on the preferred mobile network identifier information, and cause to be transmitted using the radio circuitry the CSFB service request to a core network node identifiable from the preferred mobile network identifier information and associated with one of the multiple different mobile network operators to enable the core network node to initiate the requested CSFB service for the UE,
wherein in response to sending the core network node a request to initiate the requested CSFB service for the UE, the data processing circuitry is configured to assist in establishing a circuit-switched call connection for the UE in the target CSFB cell.

43. The radio network node in claim 42, wherein the preferred mobile network identifier information includes mobile network operator index information.

44. The radio network node in claim 42, wherein the message is a connection management service request message.
